(19) United States
(12) Patent Application Publication
(10) Pub. No.: US 2002/0042722 A1
(43) Pub. Date: Apr. 11, 2002

(54) Settlement system, settlement program, settlement method, order placing device and information providing device

(76) Inventors: Takashi Tsuji, Ikoma-shi (JP); Seiichi Senoo, Shiki-gun (JP)

Correspondence Address: BIRCH STEWART KOLASCH & BIRCH, PO BOX 747, FALLS CHURCH, VA, 22040-0747, US

(21) Appl. No.: 09/973,797

(22) Filed: Oct. 11, 2001

(30) Foreign Application Priority Data
Oct. 11, 2000 (JP) 2000-311025

(51) Int. Cl. G06F 17/60

(52) U.S. Cl. 705/1; 705/16

(57) ABSTRACT

In a settlement system 1, merchandise information of merchandise which a buyer B desires to purchase is stored in a mobile information terminal 10 where the merchandise information is then displayed in the form of a barcode. A POS terminal 20 of a convenience store P scans the barcode displayed in the mobile information terminal 10, thereby performing a settling procedure. The POS terminal 20 then stores settlement completion information in the mobile information terminal 10.

Consequently, feelings of anxiety toward security for the Internet can be removed, and trade information can be collected from other information sources, such as books, thereby realizing safe trade.

### FIELD OF THE INVENTION

The present invention relates to a settlement system, a settlement program, a settlement method, an order placing device and an information providing device which execute settlement of payment in trade, such as mail-order services or the like.

### BACKGROUND OF THE INVENTION

Shown below are the existing examples of prior art related to a system in which merchandise information displayed in the form of a barcode is scanned by a POS (point of sale; point of sale information management) terminal so that payment is settled.

First, Japanese Unexamined Patent Publication No. 28329/1993 (Tokukaihei 5-28329 published on Feb. 5, 1993) discloses a technique of displaying a barcode in a display unit. This relates to an electronified barcode label which is either affixed or bonded on merchandise and the like and does not relate to a terminal to be used by a buyer with whom commerce is carried out. Therefore, the scope of use of this technique is limited.

Further, publication of a Japanese Utility Model No. 3054031 (registered on Sep. 2, 1998) discloses a technique of scanning a barcode by a POS terminal provided with a scanner in a convenience store and the like.

Further, Japanese Unexamined Patent Publication No. 16032/1999 (Tokukaihei 11-16032 published on Jan. 22, 1999) discloses a POS terminal which executes electronic settlement by using a separately provided electronic money card processor.

Here, referring to FIG. 14, the following will explain settling processes in the case of paying for merchandise in advance in conventional mail-order services. In that case, first of all, a seller introduces merchandise, for example, in a magazine or on a website (S101). Later, a buyer places an order for merchandise, for example, by telephone or on the website (S102). In response to the order for the merchandise, the seller dispatches a payment slip to the buyer (S103). In receipt of the payment slip thus dispatched, the buyer pays the seller for the merchandise (S104). Then, upon confirmation of the payment thus made by the buyer, the seller dispatches the merchandise (S105).

Further, referring to FIG. 15, the following will explain settling processes in the case of paying for merchandise later in conventional mail-order services. In that case, first of all, a seller introduces merchandise, for example, in a magazine or on a website (S111). Later, a buyer places an order for merchandise, for example, by telephone or on the website (S112). In response to the order for the merchandise, the seller dispatches the merchandise and a payment slip to the buyer (S113). Thereafter, the buyer pays the seller for the merchandise (S114).

Today, in the Internet environment, the market of electronic commerce (hereinafter referred to as “e-commerce”) is expanding. As the market expands, however, troubles due to, for example, insufficient security for a communications system show a tendency to increase. Therefore, under such circumstances, buyers are anxious about electronic settlement over the Internet. Particularly, in the case of mail-order services requiring payment in advance, it is required to transmit credit card information via the Internet when placing an order. However, it is likely that a buyer hesitates to transmit credit card information via the Internet with dubious security.

As discussed, there has been pointed out the problem of insufficient security with the Internet that is new as an infrastructure of an electronic settlement system for use in mail-order services and the like. In contrast, the POS terminal that has conventionally been provided in a convenience store and the like is superior to the Internet in terms of security and has a proven track record.

In this respect, the electronic settlement system for use in mail-order services by the Internet and the like is expected to attain as excellent security as with a conventional settlement system by the POS terminal of a convenience store and the like.

The present invention was achieved to solve the foregoing problem, and an object of which is to provide a settlement system, a settlement program, a settlement method, an order placing device and an information providing device, which are capable of realizing safe commerce by solving the problem of insufficient security with the Internet that has open specs and by collecting commercial information from other information sources including books.

### SUMMARY OF THE INVENTION

In order to solve the foregoing problems, a settlement system according to the present invention, in which, when a buyer orders merchandise for a seller, an order-intake agent receives an order for the merchandise placed by the buyer and payment for the merchandise on behalf of the seller, includes: an order placing device for storing order information inclusive of such merchandise information as to specify the merchandise that the buyer orders; and an order-intake agent device whereby the order-intake agent obtains the order information from the order placing device.

Further, in order to solve the foregoing problems, a settlement method according to the present invention, in which, when a buyer orders merchandise for a seller, an order-intake agent receives an order for the merchandise placed by the buyer and payment for the merchandise on behalf of the seller, has an arrangement in which the buyer uses an order placing device to store order information inclusive of such merchandise information as to specify the merchandise that the buyer orders, and the seller uses an order-intake agent device so that the order-intake agent obtains the order information from the order placing device.

With this arrangement, the buyer stores in the order placing device order information inclusive of such merchandise information as to specify merchandise which the buyer orders for a seller. Thereafter, the order-intake agent (convenience store, etc.) uses the order-intake agent device to obtain the order information stored in the order placing device and executes settlement of payment for the merchandise, thereby receiving the order on behalf of the seller.

Therefore, the buyer can complete placing an order and settling payment simply by storing merchandise information in the order placing device and showing it to the order-intake agent. Further, the order-intake agent can receive an order from the buyer simply by using the order-intake agent device to obtain the order information from the order placing device. For example, in the case where the buyer uses mail-order services, or the like, a plurality of orders and settlement thereof can easily be dealt with at a time when two or more pieces of merchandise information, which are obtained from various information sources including an e-mall on the Internet, television, radio, newspapers, magazines, books, and others, are stored in a single order-intake device which is then shown to the order-intake agent. Namely, when the order intake device which is one type of mobile information terminal stores two or more pieces of order information by merchandise and shows them to the order-intake agent, such as the convenience store or the like, then a plurality of order taking and settlement of payments for the orders with respect to different sellers can be dealt with in one operation, thus providing superior productivity.

Further, the buyers do not need to construct an electronic settlement system for directly settling payment to the seller. Moreover, the buyers can utilize an electronic settlement system with high-level security under the management of the order-intake agent. Furthermore, since such evidence of settlement as a receipt, etc., is issued by the order-intake agent who is the third party, the buyers' feelings of anxiety associated with trade (payment in advance, in particular) can largely be removed.

Particularly, it is observed in the Internet environment today that as the e-commerce market is expanding, troubles due to insufficient security for a communications system increases. Therefore, under such circumstances, buyers are anxious about electronic settlement executed by sending credit card details and the like over the Internet. In this respect, the foregoing settlement system does not require the buyers to send such information on an order as merchandise information and information for settlement via the Internet, thereby being free from the anxiety as discussed.

Consequently, the seller can positively offer merchandise information to the buyers in an e-mall and the like, utilizing internet infrastructures, while doing mail-order services and the like by assigning handling of settlement of payments by the buyers to the order-intake agent. On the other hand, it is available for the buyers, while continuing watching information on the Internet, to selectively obtain merchandise information provided by the sellers, store them in the order placing device, and place an order for merchandise and settle payment therefor by the order-intake agent device of the order-intake agent (i.e., a POS terminal provided in a convenience store or the like).

As discussed, with this settlement system, the feelings of anxiety toward the security for the open type Internet can be removed, and merchandise information can be collected from other information sources, such as books, thereby realizing safe e-commerce.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram schematically showing an arrangement of a settlement system according to one embodiment of the present invention.

FIG. 2 is a block diagram schematically showing an arrangement of a mobile information terminal for use in the settlement system of FIG. 1.

FIG. 3 is a flow chart of settling processes according to the settlement system of FIG. 1.

FIG. 4 is an explanatory view showing a display layout of a barcode to be displayed by a display of the mobile information terminal of FIG. 2.

FIGS. 5(a) through 5(d) are explanatory views respectively showing barcode display layouts in the case where the display of the mobile information terminal of FIG. 2 is a liquid crystal display.

FIG. 5(a) is an example of a barcode displayed by the display of the mobile information terminal.

FIG. 5 (b) is a magnified view of a region R1 shown in FIG. 5(a).

FIG. 5 (c) is a magnified view of a region R2 shown in FIG. 5(b) in the case of monochrome display.

FIG. 5(d) is a magnified view of the region R2 shown in FIG. 5(b) in the case of color display.

FIG. 6 is a block diagram schematically showing an arrangement of an electronic mall server for use in the settlement system of FIG. 1.

FIG. 7 is an explanatory view showing an example of a reference table which is referred to at electronic mall servers respectively shown in FIGS. 6 and 9.

FIG. 8 is a flow chart showing operation whereby the electronic mall server of FIG. 6 transmits screen data to the mobile information terminal.

FIG. 9 is a block diagram schematically showing another arrangement of the electronic mall server for use in the settlement system of FIG. 1.

FIG. 10 is an explanatory view showing an example of a screen data management table which is referred to at the electronic mall server of FIG. 9.

FIG. 11 is a flow chart showing operation whereby the electronic mall server of FIG. 9 transmits screen data to the mobile information terminal.

FIG. 12 is a flow chart showing operation whereby the mobile information terminal of FIG. 2 generates a barcode for display.

FIG. 13 is an explanatory view showing an example of the specs of a display section and user information which are registered in the mobile information terminal of FIG. 2.

FIG. 14 is a flow chart showing a settling procedure in the case of paying for merchandise in advance in conventional mail-order services.

FIG. 15 is a flow chart showing a settling procedure in the case of paying for merchandise later in conventional mail-order services.

### DESCRIPTION OF THE EMBODIMENTS

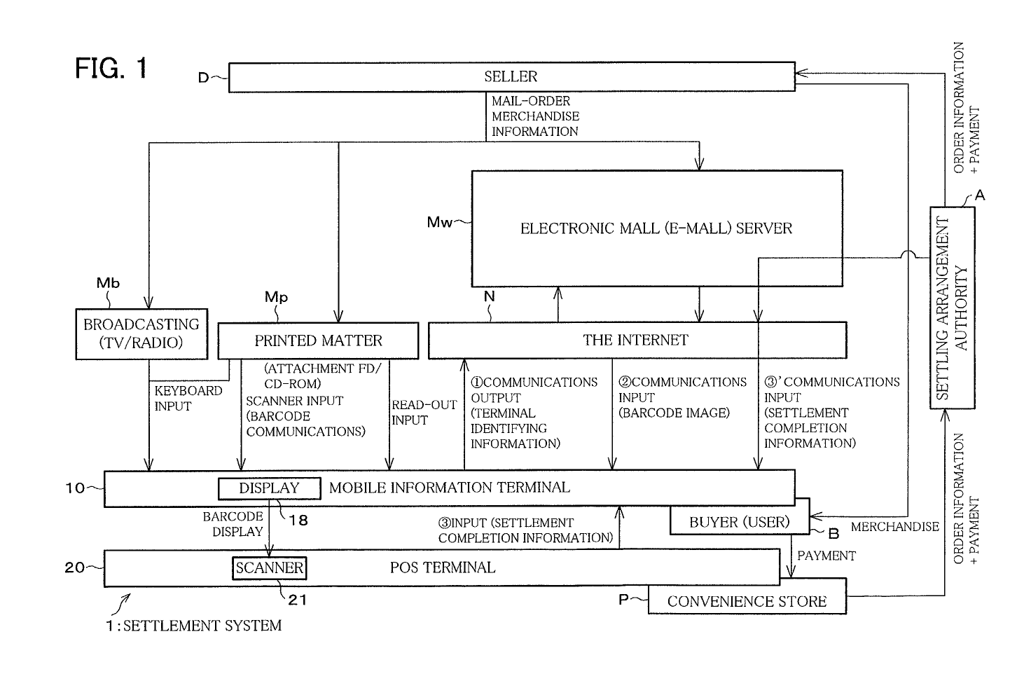

The following will explain one embodiment of the present invention with reference to FIGS. 1 to 13.

As shown in FIG. 1, a settlement system 1 according to the present embodiment has an arrangement in which, in order that a buyer B can use a mobile information terminal 10 as an “order placing device”, the mobile information terminal 10 displays information including information of merchandise for sale in seller D's mail-order services and user information in the form of a barcode. The settlement system 1 is a commercial system which settles payment for merchandise provided by mail-order services by scanning the barcode through a POS terminal (order-intake agent device) 20 provided in a convenience store P or the like which is an “order-intake agent”.

In the present embodiment, explanation will be made in the case where order information is obtained by displaying a barcode in a mobile information terminal, provided that such information as merchandise information may be of any code or symbol other than the barcode in so far as it can be inputted to an order-intake agent device. Further, as a method of obtaining order information, an obtaining method other than optical scanning may be adopted. More specifically, inputting order information according to a barcode is an idea of making good use of an existing system. Therefore, as techniques develop, it is possible that another method is adopted in addition to, or replaces, the existing method.

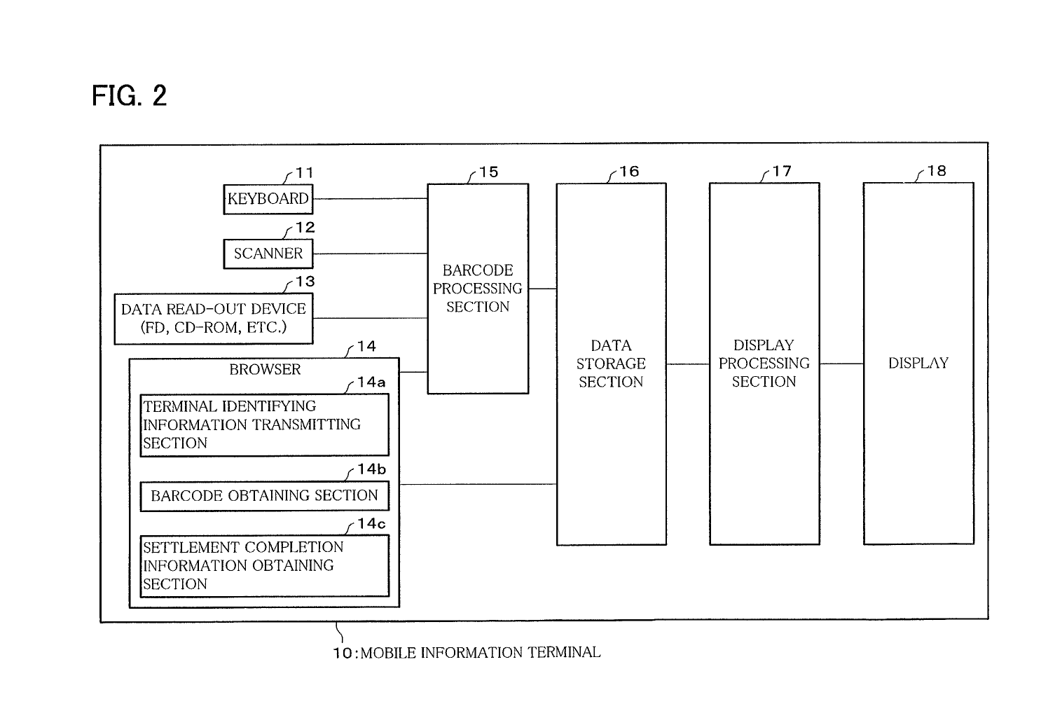

First, with reference to FIG. 2, the mobile information terminal 10 will be explained. The mobile information terminal 10 is a portable information terminal, such as a PDA (personal digital assistant), a mobile phone, and the like. In addition, the mobile information terminal 10 is provided with a keyboard 11 as input means and a display (a barcode display section) 18, such as a liquid crystal display. Note that, the keyboard 11 may be a touch panel or a keyboard realized by software. Alternatively, keyboard input may be replaced with other input means, such as handwriting input and the like.

Further, the mobile information terminal 10 includes an interface (not shown) with an external device. The interface enables the mobile information terminal 10 to utilize such devices as a scanner 12 capable of scanning graphic information, a data read-out device 13 capable of reading information out of recording media including an FD, a CD-ROM and a memory card. Note that, the scanner 12 and the data read-out device 13 may be provided within the mobile information terminal 10.

Further, the mobile information terminal 10 can log on to the Internet (a communications network) N via the interface. In addition, the mobile information terminal 10 accesses a website of the WWW (world wide web) by using a browser 14 for viewing information provided therein, thereby downloading the information. Note that, in the case where the mobile information terminal is a mobile phone, utilizing a function of the mobile phone enables a user to log on to the Internet N. In addition, the mobile information terminal 10 is compatible with other information media by providing adequate information obtaining means.

Additionally, in order to place an order for merchandise by using the settlement system, the mobile information terminal 10 includes a barcode processing section 15, a data storage section 16 and a display processing section 17.

The barcode processing section 15 converts merchandise information to a barcode. This merchandise information was inputted through the keyboard 11 or the data read-out device 13 in the form of a code of, for example, alphanumerics. Note that, the barcode processing section 15 is also capable of conversion of merchandise information in an opposite manner, that is, from a barcode to a code of alphanumerics, etc., by identifying the barcode. Further, the barcode processing section 15 can compound codes made up of two or more pieces of information so as to convert them to a single barcode.

The data storage section 16 stores information on mail-order services, such as merchandise information inputted from the keyboard 11, the scanner 12, the data read-out device 13, and/or the browser 14. In addition, the data storage section 16 previously stores information on a receiver of the merchandise, such as an address, a phone number, and the like (buyer information), which can be read out as required. Further, the data storage section 16 can store settlement completion information which certifies completion of the settlement of payment for an order, by associating it with order information.

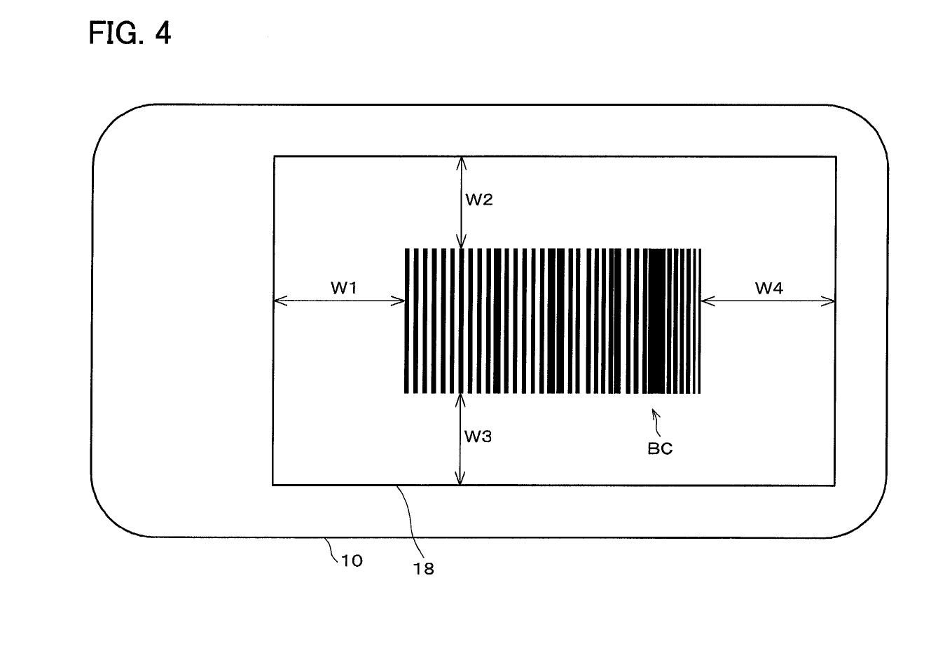

The display processing section 17 reads out order information and the like stored in the data storage section 16, and displays the order information and the like thus read out on the display 18. Particularly, a barcode image is depicted referring to reference coordinates (upper-left coordinates [W1, W2]; see FIG. 4) of the display 18.

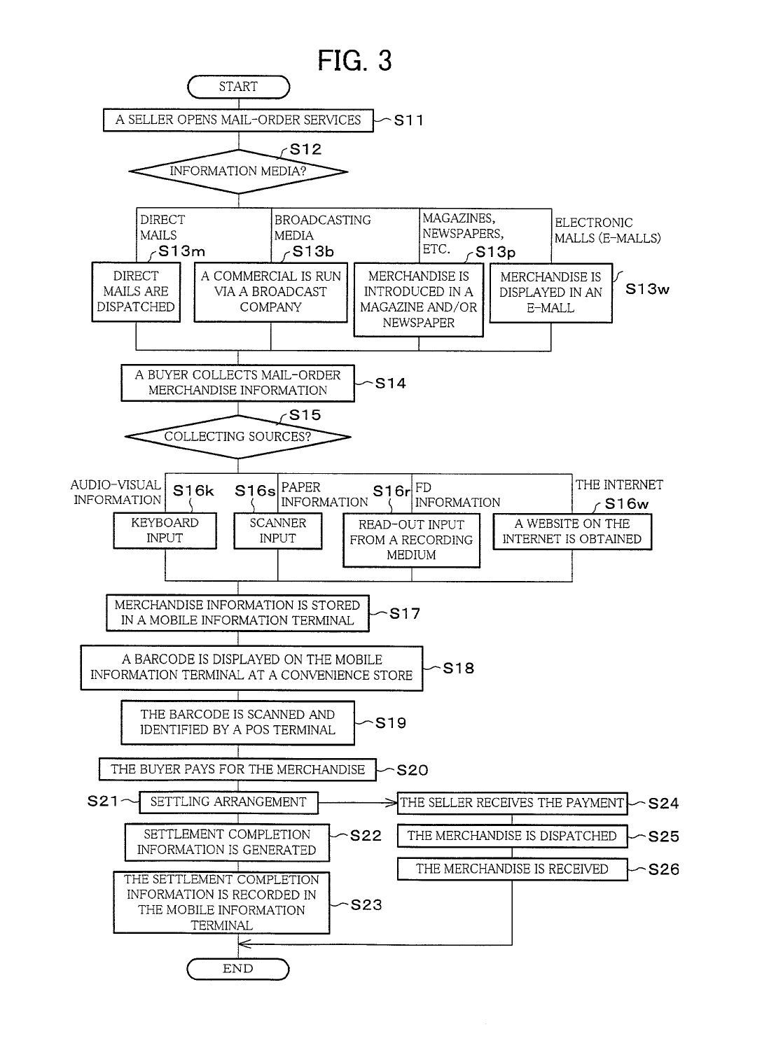

Next, the following will explain the processes in the settlement system 1 with reference to FIGS. 1 and 3.

First of all, the seller D opens mail-order services utilizing the settlement system 1 (S11). Next, the seller D provides merchandise information to various information media; for example, the various information media include broadcasting Mb, such as television, radio and the like, printed matter Mp, such as magazines, newspapers, advertisement mails and the like, electronic malls (e-mall server [information providing device] Mw) opening on the Internet N, and others (S12).

More specifically, in the case where mail-order services are provided using advertisement mails, the seller D dispatches advertisement mails (S13m). In the case where mail-order services are provided using audio-visual information, such as television, radio and the like, the seller D runs a commercial via a broadcast company (S13b). In the case where mail-order services are advertised in a magazine or newspaper, the seller D issues printed matter or recording media, such as an FD and the like (S13p). Furthermore, in the case where mail-order services are provided in an e-mall on the Internet N, the seller D provides an advertisement in the e-mall server Mw (S13w). By doing so, the seller D can provide buyers B with information on merchandise dealt with in mail-order services.

Next, in the case where the buyer B uses the mobile information terminal 10 to purchase merchandise of mail-order services, merchandise information is collected first (S14). Then, using a process which is suitable for each of various information media (broadcasting Mb, printed matter Mp, e-mall servers Mw, etc.), the buyer B obtains merchandise information of merchandise which the buyer B desires to purchase (S15, S16k, S16s, S16r and S16w) and stores the merchandise information thus obtained in the data storage section 16 (S17; merchandise information storage process).

More specifically, in the case where merchandise information is introduced in the form of a code indicative of merchandise number or the like, through audio-visual information, such as broadcasting Mb (TV, radio, etc.), or through paper information, such as printed matter Mp (magazines, newspapers, etc.), the code is inputted through the keyboard 11 (S16k). Further, when merchandise information is introduced in the form of a barcode indicative of a merchandise number or the like through such paper information as printed matter Mp, the barcode is scanned by the scanner 12 and inputted (S16s). Further, when merchandise information is distributed in a state of being recorded in a recording medium, such as an FD, a CD-ROM, a memory card or the like, merchandise information is read out by the data read-out device 13 and inputted (S16r). Further, when merchandise information is introduced in an e-mall of the e-mall server Mw, the barcode obtaining section 14b of the browser 14 is used to download a code or a barcode image indicative of a merchandise number or the like via the Internet (S16w). Note that, in the case of obtaining a barcode image, information to specify specs of the display section of the display 18 is transmitted from the terminal identifying information transmitting section 14a (FIG. 1), thereby obtaining a barcode image which suits the specs of the display section of the display 18. Further, in the absence of an optimum method of obtaining merchandise information, as in step S16k, the keyboard 11 may be used for input.

Further, in the case of obtaining a barcode image as merchandise information, the obtained merchandise information is stored in the data storage section 16. In the case of obtaining a code alone as merchandise information, a barcode image is generated from the obtained code at the barcode processing section 15, and the barcode image thus generated is stored in the data storage section 16 (S17).

Note that, in step S17, it may be arranged that merchandise information obtained and stored in a different device is transmitted to the mobile information terminal 10 via various information exchange means (e.g. infrared communications, etc.), and the merchandise information thus transmitted is stored in the data storage section 16.

Next, the buyer B carries with him/her the mobile information terminal 10 storing a barcode image indicative of merchandise information of the desired merchandise to a convenience store or the like where the POS terminal 20 which has a settling function is provided. The buyer B causes the display 18 of the mobile information terminal 10 to display the stored barcode indicative of the merchandise information (S18; an order-intake agent process), and the scanner 21 (FIG. 1) of the POS terminal 20 to scan the barcode thus displayed, thereby placing an order for the merchandise (S19; an order-intake agent process).

As described, in the processes up to step 17, merchandise information may be indicated by a code other than a barcode. However, the process of step S18 requires a barcode to be indicated. Therefore, obtaining and storing merchandise information in the form of a barcode by step S17 simplifies the procedure. In order to do so, it is possible in the e-mall server Mw to transmit a barcode image from a website.

Further, in the process of step S18, the buyer B can also input to the mobile information terminal 10 buyer information other than the merchandise information of the desired merchandise, such as destination address, phone number and the like that are required to dispatch the merchandise from the seller D to the buyer B. The format used by the buyer B when inputting the buyer information to the POS terminal 20 may be either the format of a barcode or the other format. Further, it is also possible that the merchandise and buyer information is converted to a single barcode, so that the whole information is inputted by only one barcode scanning by the scanner 21. Note that, the buyer information may be previously stored in, for example, the data storage section 16 of the mobile information terminal 10 so as to be read out as required.

Further, in the process of step S19, the scanner 21 of the POS terminal 20 scans and identifies the barcode displayed by the mobile information terminal 10. This allows the POS terminal 20 to obtain the merchandise information of the merchandise the buyer B desires to purchase in the mail-order services.

Here, the barcode is displayed by the mobile information terminal 10 in order to utilize the known POS terminal 20 provided in the convenience store P. Namely, at the convenience store P, merchandise displayed for sale is given barcode display, and the barcode information is scanned by the scanner 21 of the POS terminal 20, thereby inputting sales information of each item of merchandise. The foregoing settlement system 1 utilizes the infrastructure of the POS terminal 20 thus provided in the convenience store P so as to settle a payment for mail-order services.

As discussed, by thus inputting merchandise information to the mobile information terminal 10, displaying the inputted merchandise information together with buyer information in the form of a barcode and scanning the displayed barcode by the POS terminal 20, it is possible to place an order for merchandise in mail-order services and settle payment therefor by a simple input method. In addition, it is possible to secure evidence which is issued by such a third party as the convenience store P or the like.

Further, in the order-intake agent process (S19) by the POS terminal 20, the convenience store P also receives a payment for merchandise from the buyer B (S20). Then, the convenience store P, via the POS terminal 20, transmits the merchandise information obtained from the mobile information terminal 10 to a settling arrangement authority A, thereby executing a settlement procedure (S21). Note that, since this settling arrangement procedure is the same as the conventional one, explanation thereof will be omitted. Further, the settling arrangement authority A is one end of connection with the POS terminal 20 of the convenience store P and is defined here to include the whole infrastructures that enable e-commerce with the seller D.

On the other hand, when finishing the settling arrangement process (S21), the settling arrangement authority A pays the seller D for the merchandise that the buyer B desires to purchase (S24), and also transfers order information to the seller D. As a result, the seller D can dispatch the merchandise to the buyer B (S25). Then, when the buyer B who placed the order receives the merchandise (S26), the dealing is completed.

Note that, order information may be transmitted directly from the convenience store P to the seller D. Further, it is possible that the buyer B advises the seller D of order information by the phone or e-mall server Mw, and only the settling process is carried out at the convenience store P by using the mobile information terminal 10.

Further, when the settling arrangement process (S21) is completed, a control number (settlement completion information) that corresponds to a receipt indicative of completion of the settling procedure is issued (S22). Therefore, it is possible that the buyer B awaits the issuance of the settlement completion information, thereafter storing the settlement completion information obtained by a settlement completion information obtaining section 14c (FIG. 1) in the data storage section 16 of the mobile information terminal 10 (S23).

As discussed, that the buyer B obtains settlement completion information, which corresponds to a receipt, from the convenience store P, the third party, can prevent trouble with the seller D.

Note that, at the time an electronic settlement for merchandise is completed, the input of the settlement completion information to the mobile information terminal 10 in step S23 can be performed by communications from the POS terminal 20 (\mathring{3} of FIG. 1). Further, it is also possible that the buyer B is given a control number assigned to the settlement completion information which is shown in a receipt of payment and the like, and the buyer B registers the settlement completion information in the mobile information terminal 10. Further, in response to the completion of the electronic settlement by the POS terminal 20, the settling arrangement authority A or the seller D can transmit the settlement completion information to the mobile information terminal 10 via the e-mall server Mw or the like (\mathring{3}′ of FIG. 1).

Next, with reference to FIGS. 4 to 11, a procedure of transmitting a barcode image from the e-mall server Mw to the mobile information terminal 10 will be explained. Note that, the e-mall server Mw can be configured having as its base a general-purpose computer, such as a work station, a personal computer or the like, and constructs a website of a service provider or the like on the Internet.

A first purpose of displaying a barcode by the mobile information terminal 10 in the settlement system 1 is to allow the POS terminal 20 to read the displayed barcode. Therefore, this purpose cannot be achieved when the barcode displayed on the display 18 of the mobile information terminal 10 extremely leans to one side of the screen or cut at an end of the screen. Namely, the barcode must be displayed on the display 18 of the mobile information terminal 10 so that it can be scanned by the POS terminal 20 (FIG. 4).

As shown in FIG. 4, a display layout of a barcode BC to be displayed on the display 18 of the mobile information terminal 10 is determined so that the barcode BC is positioned inside of the peripheral portion of a displayable area by a predetermined width. More specifically, the barcode BC is displayed in the middle of the display 18 while providing margins (barcode display prohibition regions) of at least marginal widths W1, W4, W2 and W3 on the left and right and top and bottom of the screen, respectively, which are measured from the frame of the display 18.

In order that the scanner 21 of the POS terminal 20 that is provided in the convenience store P can easily scan the barcode BC from the display 18 of the mobile information terminal 10, the marginal widths W1 to W4 can be determined according to the shape (physical size) of a head of the scanner 21. More specifically, when the marginal widths can thus be determined according to the shape of the head of the scanner 21 of the POS terminal 20 that is assumed to be used in scanning the barcode BC, the maximum marginal widths are defined as W1 to W4, respectively, and a barcode display layout to satisfy the definition is added to a display design.

In addition, in the case where the display 18 of the mobile information terminal 10 is a liquid crystal display, in order to prevent such a defect that a partially defective display of the liquid crystal display due to the loss of pixels, etc., results in linking line display regions or non-display regions between lines of the barcode BC, the barcode display layout is determined such that the display and non-display regions, i.e., each line and each space between the lines respectively have a width of at least two pixels.

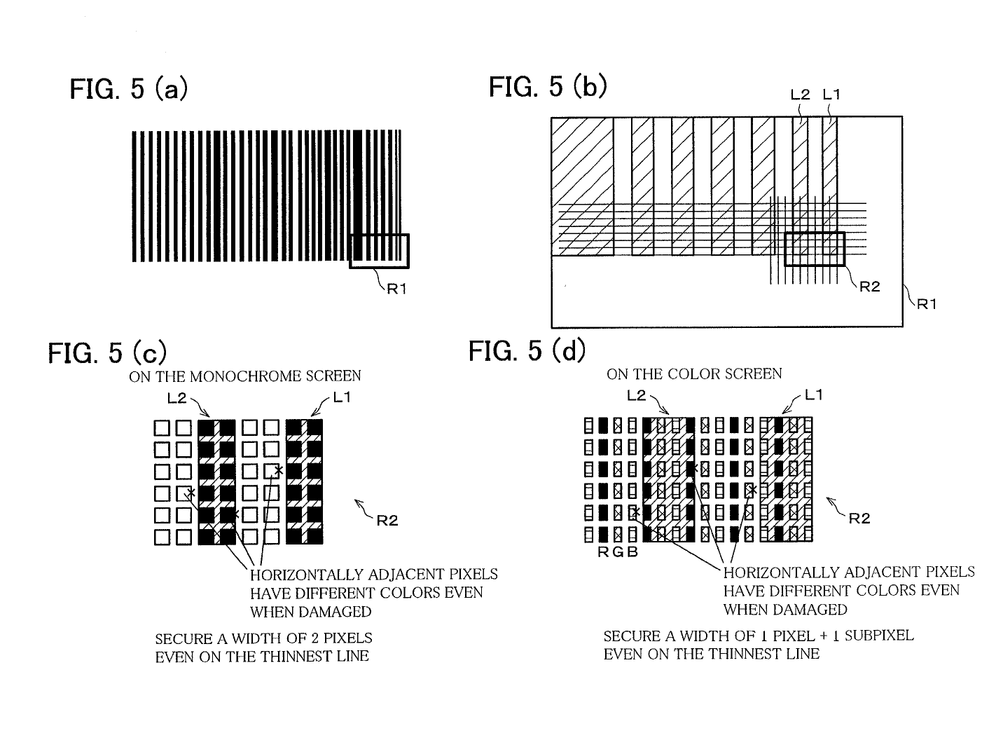

More specifically, as shown in FIGS. 5(a), 5(b) and 5(c), in the case of monochrome display, it is set that a width of thinnest lines (L1, L2) of the barcode BC, and a width of a space between the lines are 2 pixels, respectively. Further, as shown in FIGS. 5(a), 5(b) and 5(c), in the case of color display, since one pixel (dot) is composed of three subpixels of the three primary colors R, B and G, the width of the thinnest lines (L1, L2) of the barcode BC and the width of the space between the lines are set to be 1 pixel +1 subpixel, respectively. By displaying with this barcode display layout, even when a deficient portion of 1 pixel or 1 subpixel emerges in the display 18, a barcode can be displayed without a defective link, thereby allowing the POS terminal 20 to accurately identify the barcode.

Note that, in the settlement system 1, it goes without saying that the display device (display 18) for displaying the barcode BC, that is included in the mobile information terminal 10, is not limited to the liquid crystal display. Namely, the foregoing display method can be adopted to any displays in which display elements (pixels or subpixels) are aligned in a matrix, and each of the display elements may possibly be damaged.

Next, two different methods of transmitting a barcode image of the foregoing barcode display layout from the e-mall server Mw to the mobile information terminal 10 will be explained.

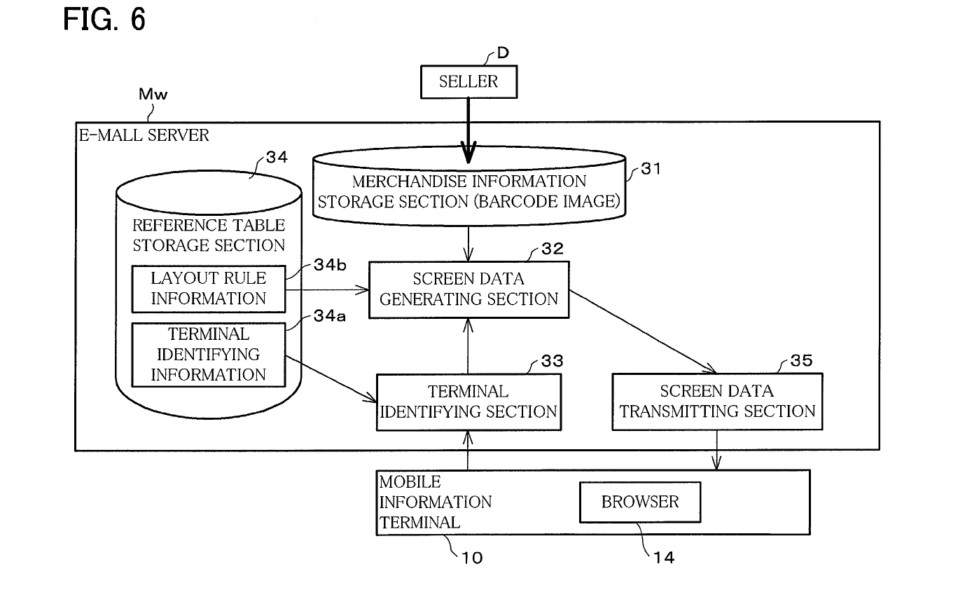

The first method is such that the e-mall server Mw identifies the mobile information terminal 10, generates screen data to match the specs of the display section of the mobile information terminal 10, and transmits the screen data thus generated. In that case, the e-mall server Mw can be configured as shown in FIG. 6.

As shown in FIG. 6, the e-mall server Mw includes a merchandise information storage section 31, a screen data generating section 32, a terminal identifying section 33, a reference table storage section 34, and a screen data transmitting section 35.

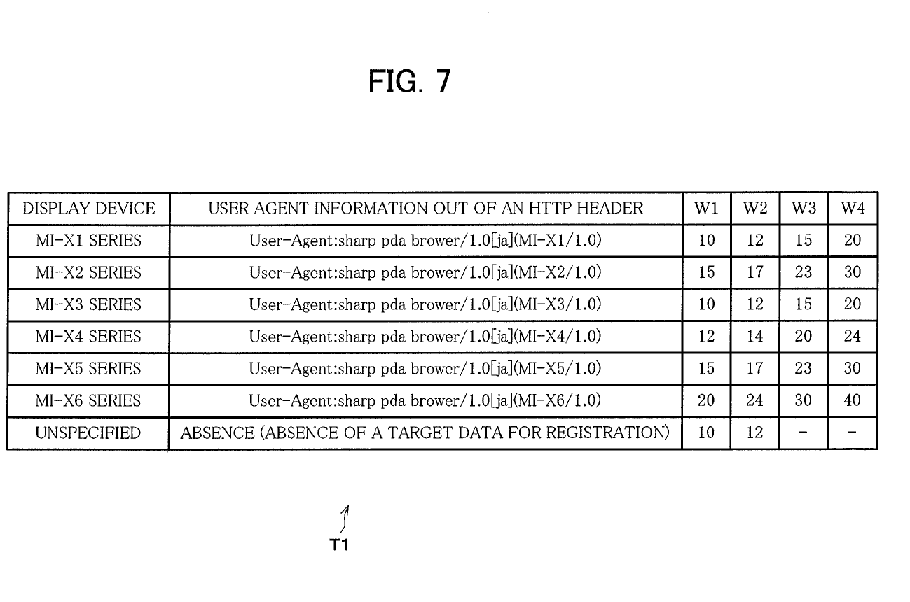

First of all, the reference table storage section 34 stores terminal identifying information 34a (user agent information) for identifying the mobile information terminal 10, and layout rule information 34b corresponding to the marginal widths W1 to W4 shown in FIG. 4. More specifically, as a reference table T1 shown in FIG. 7, the user agent information in an HTTP header and the marginal widths W1 to W4 are stored for each model of the mobile information terminal 10. Note that, in the reference table T1 are registered default marginal widths W1 to W4 for a mobile information terminal 10 whose model (i.e., display section specs) cannot be specified based on user agent information contained in the received HTTP header.

The user agent information discussed above refers to a character string indicative of a title, version, etc., of the browser 14 as being a client program of the mobile information terminal 10. The user agent information is transmitted from the mobile information terminal 10 (terminal identifying information transmitting section 14a) to the e-mall server Mw. More specifically, when requesting information (merchandise information, etc.) on an e-mall from the e-mall server Mw via the Internet, the mobile information terminal 10 transmits user agent information as the content of a User-Agent header of a request header according to HTTP communications. Accordingly, in the e-mall server Mw, the terminal identifying section 33 obtains the character string so as to refer to the reference table T1, thereby judging the model, etc., of the mobile information terminal 10.

Further, the layout rule information 34b refers to the marginal widths W1 to W4 (FIG. 4) which define the position of the barcode BC to be displayed on the display 18 of the mobile information terminal 10. Accordingly, by referring to the reference table T1 of FIG. 7, a barcode display layout for each model of the mobile information terminal 10 can be identified. For example, in the case of the MI-X1 series mobile information terminal 10, it is identified that the marginal widths W1 to W4 are 10, 12, 15 and 20 dots, respectively. Note that, the display 18 of the mobile information terminal 10 is a dot display screen of, for example, VGA (640 dots wide ×480 dots high) or SVGA (800 dots wide ×600 dots high). Therefore, the marginal widths W1 to W4 can be set by converting them to the number of dots. Note that, the representation in dots can be converted to representation in pixels for color display according to FIGS. 5(c) and 5(d).

Further, the merchandise information storage section 31, which is previously provided by the seller D with barcode images of merchandise information of merchandise that the seller D sells, stores the barcode images by merchandise. Note that, the merchandise information storage section 31 may store barcode images which are prepared in accordance with the display section specs of the display 18, based on code information provided by the seller D.

The screen data generating section 32 generates screen data to display a barcode of the requested merchandise information on the display 18, in accordance with layout rules (marginal widths W1 to W4) corresponding to the display section specs of the display 18 of the mobile information terminal 10. More specifically, barcode display screen data is generated by setting the barcode to have the width of the thinnest line of 2 dots and the line length within such a range as to be determined according to the display section specs (the number of dots with respect to the height and width as well as the marginal widths W1 to W4 of the display 18).

The terminal identifying section 33, based on data transmitted from the terminal identifying information transmitting section 14a, refers to use agent information in the reference table T1 and identifies a model, etc., of the mobile information terminal 10.

The screen data transmitting section 35 transmits screen data to the browser 14 (barcode obtaining section 14b) of the mobile information terminal, that requested the merchandise information.

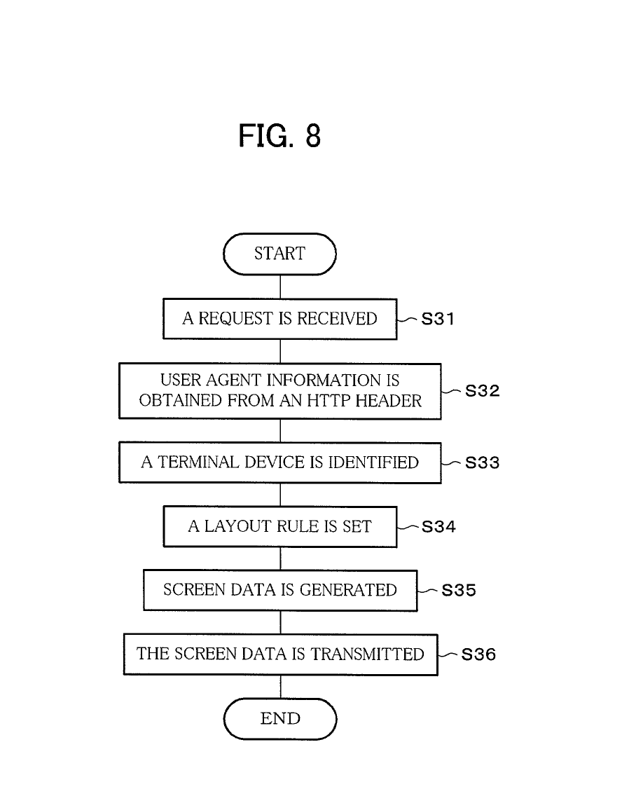

FIG. 8 is a flow chart showing a procedure of generating and transmitting a barcode display screen at the time the e-mall server Mw (FIG. 6) receives a request for transmission of merchandise information from the mobile information terminal 10.

When the e-mall server Mw receives the request for transmission of merchandise information from the mobile information terminal 10 (S31, \mathring{1} of FIG. 1), the terminal identifying section 33 obtains the content of a user agent header from a request header of an HTTP header (S32), refers to user agent information in the reference table T1 and identifies the model of the mobile information terminal 10 (S33).

Next, the screen data generating section 32 obtains layout rule information, i.e., marginal widths W1 to W4 for the model according to the results of identification from the reference table T1 (S34). Thereafter, the screen data generating section 32, in accordance with the layout rules thus obtained, generates screen data to display the barcode BC read out of the merchandise information storage section 31 by request of the mobile information terminal 10 on the display 18 of the mobile information terminal 10 (S35). At the end of the sequence, the screen data transmitting section 35 transmits the generated screen data as response to the mobile information terminal 10 (barcode obtaining section 14b) (S36, \mathring{2} of FIG. 1).

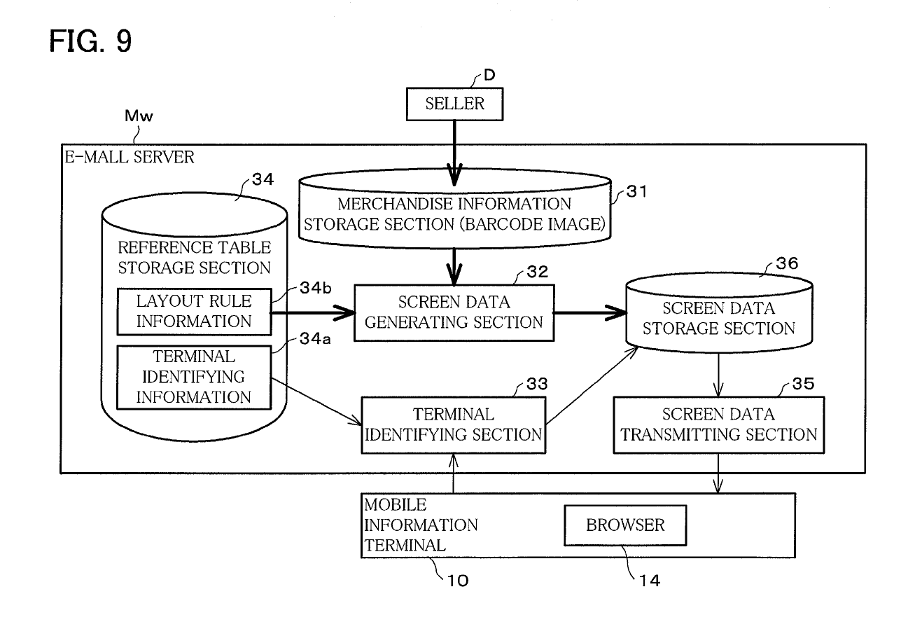

The second method is such that a barcode image is previously generated to match the display section specs of the display 18 of the mobile information terminal 10 assumed to be used, and the barcode image thus generated is transmitted depending on the results of identification of the mobile information terminal 10 that actually made a request. In that case, the e-mall server Mw can be configured as shown in FIG. 9.

As shown in FIG. 9, the e-mall server Mw includes a merchandise information storage section 31, a screen data generating section 32, a terminal identifying section 33, a reference table storage section 34, a screen data transmitting section 35, and a screen data storage section 36. Namely, the e-mall server Mw basically has the same configuration as that of the e-mall server Mw shown in FIG. 6, except for inclusion of the screen data storage section 36.

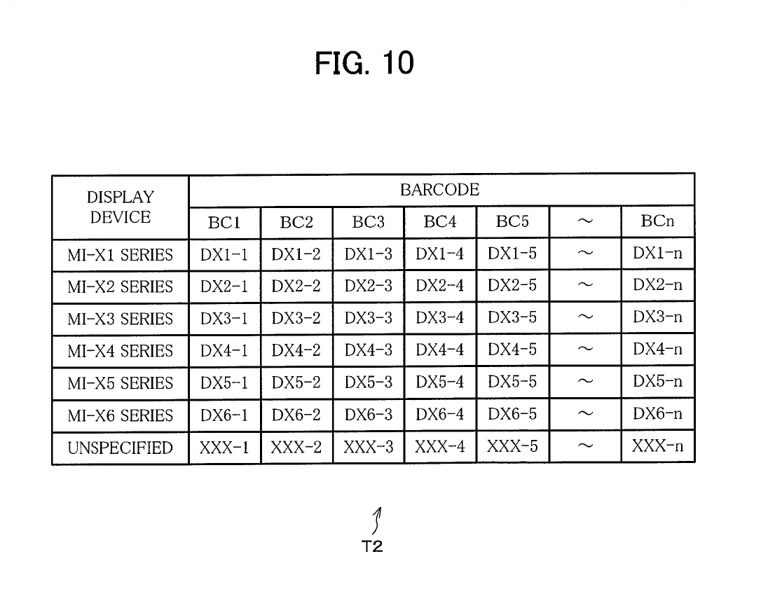

In this e-mall server Mw, the merchandise information storage section 31 is previously provided by the seller D with barcode images of merchandise information of merchandise that the seller D sells, and the barcode images are stored by merchandise. Further, the screen data generating section 32, in accordance with layout rules (marginal widths W1 to W4) corresponding to the display section specs of the display 18 of the mobile information terminal 10, respectively generates screen data inclusive of the barcode images of merchandise information for display on the displays 18 of mobile information terminals 10 which are assumed to have access to the e-mall server Mw. In addition, the screen data generating section 32 generates a management table T2 (FIG. 10) for managing the created screen data. Note that, the screen data management table T2 may be stored in the screen data storage section 36.

Here, FIG. 10 is an explanatory view showing an example of the screen data management table T2. In the screen data management table T2 of FIG. 10 are registered screen data DX1-1 to DX1-n through DX6-1 to DX6-n, which were generated so as to display n types of barcodes BC1 to BCn corresponding to each terminal name on the display 18 compatible with 6 types of display section specs. In addition, in the screen data management table T2 are registered default screen data XXX-1 to XXX-n, which is generated for such a mobile information terminal 10 that its model (i.e., display section specs) cannot be specified based on user agent information in the received HTTP header.

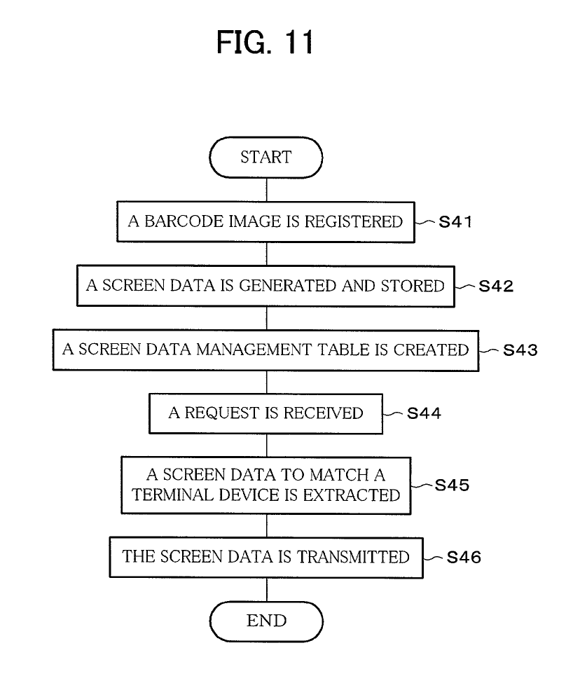

FIG. 11 is a flow chart showing a process in which the e-mall server Mw (FIG. 9) previously generates a barcode display screen with respect to the mobile information terminal 10 assumed to have access to the e-mall server Mw, and reads out and transmits the display screen in response to a request for transmission of merchandise information.

More specifically, in the e-mall server Mw, when the seller D registers information on merchandise (explanation of merchandise, a barcode image of merchandise information, etc.) for display in the e-mall (S41), the screen data generating section 32 generates screen data to be used in displaying the barcode image stored in the merchandise information storage section 31 in each of the mobile information terminals 10 of various models which are assumed to make requests, in accordance with the layout rule information (marginal widths W1 to W4) of the reference table T1. In addition, the screen data generating section 32 stores the generated screen data in the screen data storage section 36 (S42). In that case, the screen data generating section 32 creates a screen data management table T2 (S43).

Further, when receiving from the mobile information terminal 10 a request for transmission of merchandise information (S44, \mathring{1} of FIG. 1), the terminal identifying section 33 obtains the content of a user agent header from a request header of an HTTP header, and refers to user agent information of the reference table T1, thereby identifying the model of the mobile information terminal 10. The terminal identifying section 33 extracts from the screen data storage section 36 the screen data that matches a model identification result according to the screen data management table T2 (S45). At the end of the sequence, the screen data transmitting section 35 transmits the extracted screen data as response to the mobile information terminal 10 (S46, \mathring{2} of FIG. 1).

As described, with the use of either of the first and second methods, the e-mall server Mw can transmit screen data for displaying a barcode image, which was prepared according to barcode display layouts (FIGS. 4 and 5) which are different depending on a model of the mobile information terminal 10 that accesses the e-mall server Mw, to the mobile information terminal 10 via the Internet N. This makes it possible to provide the buyers B with barcode screen according to the settlement system 1.

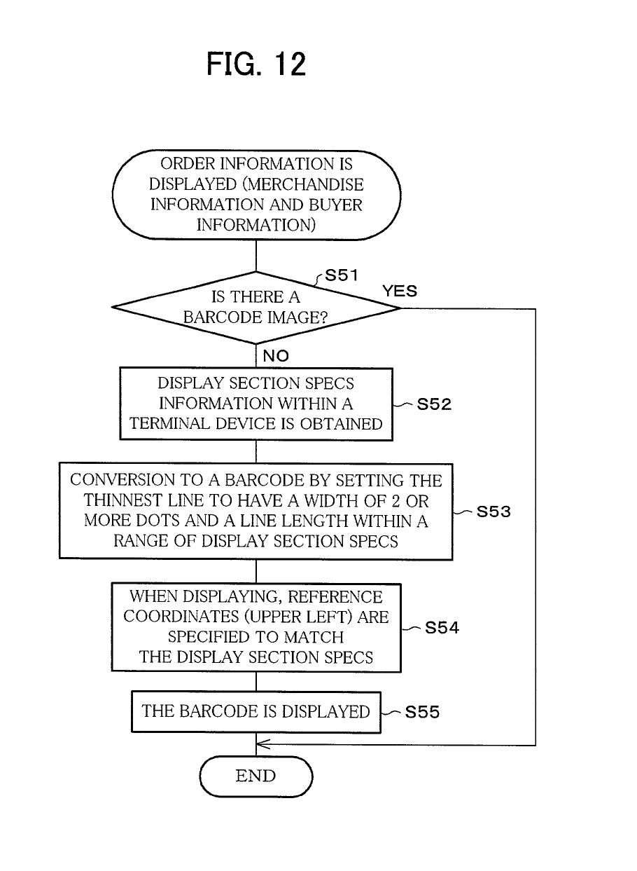

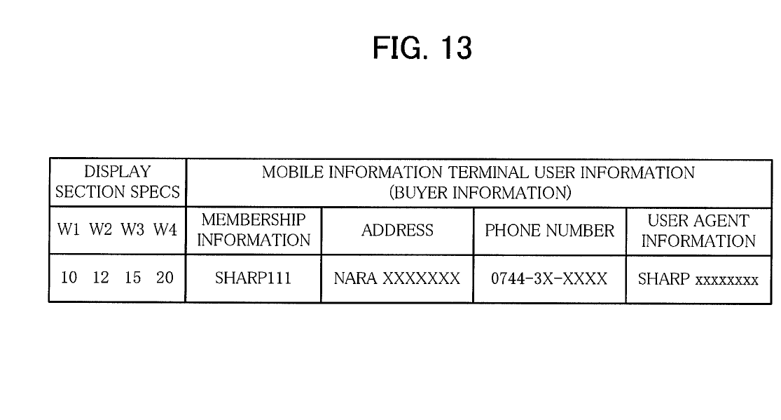

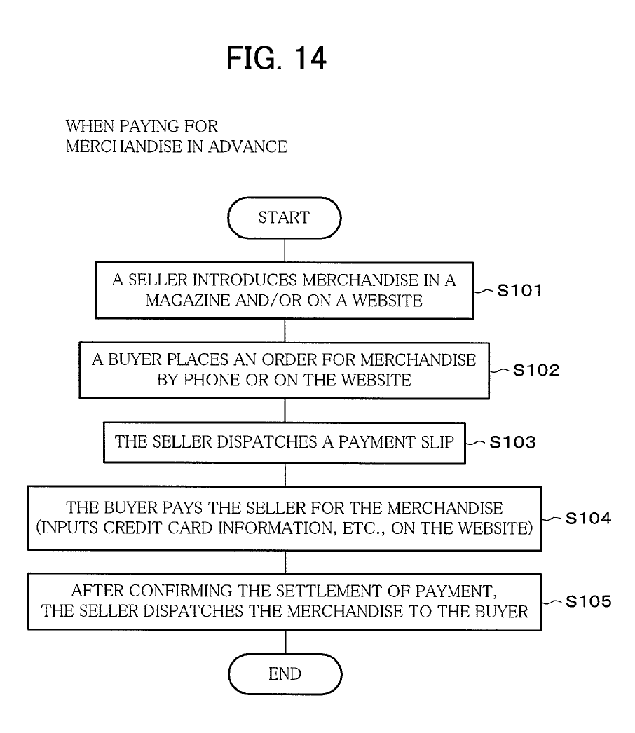

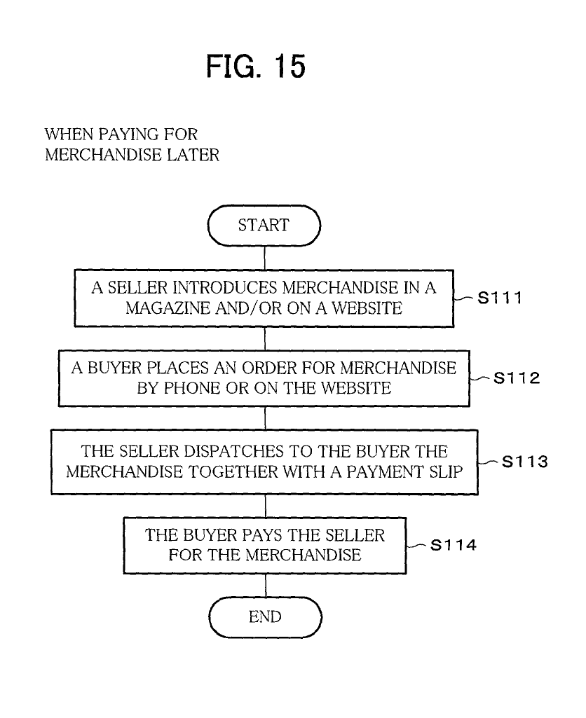

The following will explain a case where the mobile information terminal 10 performs conversion to a barcode for display, with reference to FIGS. 12 and 13.

As shown in FIGS. 1 and 2, the mobile information terminal 10 can obtain merchandise information in a format of a code, but not a barcode, via the keyboard 11 and the data read-out device 13. In that case, merchandise information is respectively converted to a barcode and displayed by the barcode processing section 15 of the mobile information terminal 10.

FIG. 12 is a flow chart showing the operation in which the mobile information terminal 10 generates a barcode and displays it. Further, FIG. 13 shows an example of display section specs and user information which are registered in the mobile information terminal 10.

As shown in FIG. 12, in the case of displaying merchandise information whose barcode image is not obtained (NO in S51), information of the display specs (FIG. 13) is obtained (S52), conversion to a barcode is performed based on the code (alphanumerical information) inputted from the keyboard 11, the data read-out device 13 and the like, by setting the barcode to have the width of the thinnest line of not less than 2 dots and the line length within a range of the display section specs. More specifically, the line length is thus set so that it does not exceed a width which is obtained by subtracting the total number of dots of the top and bottom marginal widths W2 and W3 (FIG. 4) from the number of dots in a vertical direction of the displayable screen area of the display 18. Further, the top left corner of the barcode is specified to match the reference coordinates (W1, W2) (FIG. 4) of the display 18 (S54), thereby displaying the barcode (S55).

Here, in the case where the barcode display of user information of the mobile information terminal 10 is demanded when inputting order information from the mobile information terminal 10 to the POS terminal 20, only the necessary information of the user information shown in FIG. 13 can be displayed after converting it to a barcode according to the procedure of FIG. 12.

Note that, steps S53 and S54 in which the barcode display layout of FIG. 12 is determined are adopted for generation of screen data (S35, S42) shown in FIGS. 8 and 11, where a barcode image can be created by the same rules.

Here, as described, the barcode processing section 15 (FIG. 2) of the mobile information terminal 10 if provided with a function to convert a code, such as alphanumerics and the like, to a barcode image matching the display section specs of the display 18, and a function to perform conversion in an opposite manner, i.e., from the barcode to the code by identifying the barcode image. Further, the barcode processing section 15 can compound codes of two or more pieces of information so as to convert them to a single barcode.

Therefore, even in the case where a barcode image scanned with the scanner 12 from, for example, a newspaper, a magazine or the like, is not compatible with the display section specs of the mobile information terminal 10, the mobile information terminal 10 first converts the scanned barcode image to the state of a code, then, generates a barcode image that matches its own display section specs based on that code and displays it.

Further, when an image is scanned by the scanner 12, and the scanned image includes a barcode image, the mobile information terminal 10 automatically isolates the barcode image, identifies it, and stores the identified barcode image as code information (numerical value information) in the data storage section 16. Note that, the isolation of the barcode image from the image data is performed by identifying a region which includes not less than a predetermined amount of parallel line segment images of a predetermined length. Further, when displaying a barcode image on the display 18, the mobile information terminal 10 can generate the barcode image compatible with the display section specs thereof and display the barcode image thus generated, according to code information stored in the data storage section 16.

Further, when the mobile information terminal 10 obtained the barcode image, it can display a code on the display 18, that was obtained by identifying the barcode image. Therefore, the buyer B can check the inputted barcode by making comparison between the code displayed on the display 18 and a code indicated in the vicinity of the barcode in the newspaper, magazine or the like. Further, when the barcode processing section 15 cannot identify the inputted barcode image, the mobile information terminal 10 can suggest the buyer B to input the code indicated in the vicinity of the barcode in the newspaper, magazine or the like by the keyboard 11. Note that, if the buyer B inputs the code of barcode by the keyboard 11 when the barcode is read, the mobile information terminal 10 can check the inputted barcode image before displaying it.

Further, the mobile information terminal 10 can display a barcode image in such a manner that it generates one or more barcode images compatible with the display section specs thereof based on, for example, code information of merchandise information obtained from the outside via the scanner 12 or the like, and code information of the previously stored information (the total number ordered, destination address, etc.) in the data storage section 16.

As discussed, it is generally observed that the e-commerce market is expanding in the Internet environment, however, troubles due to insufficient security for a communications system, for example, show a tendency to increase. Therefore, under such circumstances, buyers are anxious about electronic settlement executed by a mobile information terminal.

Accordingly, the settlement system 1 provides an environment in which mail-order services can be used safely without impairing convenience, by utilizing the POS terminal 20 provided in the convenience store P and the like, which has an electronic settling facility and exclusively used for that purpose. Importantly, since the POS terminal 20 is a device exclusively used for electronic settlement, its line security level is set high. Further, when settlement is executed by the POS terminal 20, the third party, such as the convenience store P or the like, issues such evidence as a paper or electronic receipt. Therefore, by adopting the settlement system 1, it is possible to largely remove feelings of anxiety that the buyer B has with respect to mail-order services on the Internet.

More specifically, in the settlement system 1, the buyer B inputs merchandise information of the merchandise that he/she desires to purchase from the e-mall server Mw, such as a service provider or the like, to the mobile information terminal 10 via the Internet, thereby temporarily storing the merchandise information. Thereafter, the buyer B settles payment by allowing a barcode of the merchandise information displayed in the mobile information terminal 10 to be scanned by the POS terminal 20 which has the electronic settling facility land is used exclusively for that purpose.

This enables the seller D to positively offer merchandise information to the buyers B in the e-mall, etc., by utilizing the internet infrastructure, and the buyers B to selectively obtain the merchandise information thus offered, store it in the mobile information terminal 10, and execute settlement by the POS terminal 20 provided in the convenience store P or the like. Therefore, electronic settlement with high-level security can be realized. Moreover, when settlement is executed by the POS terminal 20, such evidence of settlement as a receipt is issued by an intermediary, such as the convenience store P or the like, which is the third party, thereby removing feelings of anxiety associated with trade.

Further, the settlement system 1 is capable of input and storage of merchandise information based on broadcasting Mb including television and radio, printed matter Mp including books and catalogs, and others, in addition to the Internet N. This makes it possible to obtain merchandise information from a variety of information media, temporarily store it in the mobile information terminal 10, and execute settlement by the POS terminal 20.

Further, in the settlement system 1, the mobile information terminal 10 is used to obtain merchandise information of the merchandise for which the buyer B places an order as well as the personal information of the buyer B via the keyboard 11, the scanner 12, the data read-out device 13, the Internet N and others. Then, at the time of dealing in the convenience store P, not only the merchandise information but also the buyer information are displayed in the form of a barcode in the mobile information terminal 10, thereby inputting the information to the POS terminal 20. Consequently, the settling process with the use of the POS terminal 20 can readily be realized. Further, with respect to an order by the buyer B, evidence of settlement can be issued by the third party at the convenience store P.

Further, in the settlement system 1, the mobile information terminal 10 displays the obtained merchandise information in the form of a barcode, and the POS terminal 20 scans the barcode displayed in the mobile information terminal 10 so as to deal with a settling procedure. In addition, the POS terminal 20 stores settlement completion information in the mobile information terminal 10. This enables the mobile information terminal 10 to store result information indicating that merchandise information is obtained from various input means, which is then displayed in the form of a barcode in the mobile information terminal 10, and the barcode thus displayed is identified by the scanner 21 of the POS terminal 20 provided in the convenience store P so as to perform e-commerce. consequently, since evidence of electronic settlement is issued by the intermediary (order-intake agent), such as the convenience store P, as the third party, troubles associated with trade can be prevented, thereby removing feelings of anxiety that the buyers B have with respect to trade (and payment in advance, in particular).

Even when paying later, payment can be made together with other payments if the buyer B, who received merchandise, brings the mobile information terminal 10 storing a barcode indicative of merchandise information to the convenience store P. Thus, efficiency in the process is high. Further, since the convenience store P is open for 24 hours, that eases the process. In contrast, payment at a bank, a post office or the like is not easily done because few of them are open for 24 hours at the present time. In addition, even if the payment can be done at the bank, the post office or the like, payment to the settling arrangement authority A may be delayed, and therefore it is not preferable. Note that, in the case where, in mail-order services, payment for merchandise is made to a carrier of delivery services upon delivery of the merchandise, this is excluded from the target of the settlement system 1.

Further, in the settlement system 1, the e-mall server Mw distributes a barcode image of merchandise information from the e-mall opened on the Internet so that the barcode image is compatible with the display section specs of the mobile information terminal 10. Thus, the e-mall server Mw (seller D) can distribute a barcode by taking into consideration its display layout when displayed by the mobile information terminal 10 (buyer B).

Further, in the settlement system 1, the mobile information terminal 10 displays a barcode within the bounds of effective scanning of the scanner 21 of the POS terminal 20 in the display 18, for example, in the center of the display 18. This enables the scanner 21 of the POS terminal 20 to scan the barcode displayed by the mobile information terminal 10.

In the settlement system 1, a barcode is displayed on the display 18 of the mobile information terminal 10 in such a display format that, in the case of monochrome display, the thinnest line of the barcode is not less than 2 dots, and in the case of color display, a line width is not less than 2 pixels +1 subpixel. This enables the barcode to be displayed while securing a predetermined width between the lines. Therefore, even when some dots in the display 18 are lost, the loss of an edge of the barcode is prevented, thereby preventing reduction in the accuracy of scanning by the scanner 21 of the POS terminal 20.

The objective of the present invention can be achieved in such a manner that the mobile information terminal 10 and the e-mall server Mw are provided with a program code (an execute form program, an intermediate code program, a source program) of a settlement program which is software to realize the foregoing features, or a recording medium having the settlement program code in a computer-readable format recorded therein, and the settlement program code is read out for execution by computers (alternatively, a CPU or MPU) of the mobile information terminal 10 or the e-mall server Mw. In that case, it is the settlement program code itself that realizes the foregoing features, and thereby the settlement program code and the recording medium in which the settlement program code is recorded make up the present invention.

As discussed, a computer-readable recording medium according to the present invention, in which a settlement program is recorded, causes a computer to realize the facilities of the mobile information terminal 10 (FIG. 2) and/or the e-mall server Mw (FIGS. 6, 9), thereby operating the settlement system. This enables the settlement program read out of the recording medium to realize the mobile information terminal 10 and/or the e-mall server Mw according to the settlement system in the computer. Therefore, the effects of the settlement system 1 can be attained.

The recording medium for providing a program code can be arranged as detachable from a system or device. in addition, the recording medium may be a medium steadily carrying the program code so that the medium can provide the program code. Further, the recording medium may be arranged that it is loaded into the system or device so that the computer can directly read the recorded program code, or the recording medium is loaded so that it can read the program code via a program read-out device connected to the system or device as an external storage device.

For example, as this recording medium, the following can be adopted: a tape system including a magnetic tape, a cassette tape, etc.; a disk system including such a magnetic disk as a floppy disk, a hard disk, etc., and such an optical disk as a CD-ROM, an MO, an MD, a DVD, a CD-R, etc.; a card system, such as an IC card (including a memory card), an optical card, etc.; and a semiconductor memory system including a mask ROM, an EPROM, an EEPROM, a flash ROM, etc.

Further, the foregoing program code may be recorded so that the computer can read it out of the recording medium to directly execute it, or so that it is first transferred from the recording medium to a program storage region of a main memory, then, the computer reads it out of the main memory for execution.

Further, the recording medium may be a medium fluidly carrying a program code so that it can provide the program code via the communications network and the like. In that case, the system or device is arranged that it can be connected to the communications network (including the Internet, intranet, etc.), and the program code can be provided by being downloaded from the communications network.

Note that, it is assumed that a program to read the program code out of the recording medium and store it in the main memory, and a program to download the program code from the communications network are previously stored in the system or device in a computer-readable manner.

The foregoing features can be realized when the computer executes the read-out program code, and in addition, when an OS (Operating System) or the like which is operating in the computer executes part or full of actual processing based on a command by the program code.

Further, the foregoing features can be realized in such a manner that the program code read out of the recording medium is written into a memory which is included in either a function extension board mounted on a computer or a function extension unit connected to the computer, thereafter, based on a command by the program code, a CPU or the like included in the function extension board or unit executes part or full of actual processing.

As discussed, a settlement system according to the present invention is such that the order information further includes such buyer information as to specify the buyer.

With this arrangement, further, the buyer stores in an order placing device such merchandise information as to specify merchandise which the buyer orders for a seller and the buyer information to specify the buyer. Thereafter, an order-intake agent uses an order-intake agent device to obtain the order information stored in the order placing device and receives the order on behalf of the seller by executing settlement of payment for the merchandise.

Therefore, the order-intake agent device receives input of the buyer information as well as the merchandise information. Namely, thus obtaining the order information enables the order-intake agent device to automatically obtain such information as the destination of the merchandise, and the like, together with the merchandise information. In addition, thus obtaining the order information enables the order-intake agent device to automatically obtain information on a payer necessary for settlement, together with the merchandise information, thereby making it possible to automatically issue evidence of settlement which specifies the buyer (payer). Note that, the buyer information may include credit card details.

Consequently, for the buyer and the order-intake agent, the processes of ordering and settlement utilizing the order-intake agent device become easier.

As discussed, a settlement system according to the present invention further has an arrangement in which the order placing device displays the order information in the form of a barcode, and the order-intake agent device obtains the order information by scanning the barcode displayed in the order placing device.

Further, as discussed, an order placing device according to the present invention is used for the foregoing settlement system and includes a barcode display section for displaying the order information in the form of a barcode.

With this arrangement, further, the buyer stores in the order placing device either merchandise information or order information inclusive of the merchandise information and buyer information, and the order information is displayed in the form of a barcode in the order placing device. Thereafter, the order-intake agent uses the order-intake agent device to scan the barcode displayed in the order placing device, thereby obtaining the order information stored in the order placing device, while receiving the order on behalf of the seller by executing payment for the merchandise.

Consequently, since the order-intake agent device can obtain the order information only by the operation of scanning the barcode, it is not necessary to electrically connect the order placing device and the order-intake agent device with or without wires. Therefore, for the buyer and the order-intake agent, the processes of ordering and settlement utilizing the order-intake agent device are easy.

Here, it is observed today that convenience stores are spread all over the nation, and electronic settlement utilizing a POS terminal used exclusively for scanning a barcode is widely performed in the stores. Moreover, since this POS terminal is exclusively used for electronic settlement, the line security level is set high.

Therefore, as discussed, displaying the order information in the from of a barcode in the order placing device enables the use of the existing electronic settlement system provided in the convenience store and the like.

As explained, the seller designates as the order-intake agent the convenience store or the like which can easily be used by the buyers, and the POS terminal thereof is utilized as the order-intake agent device, thereby making it possible to provide an environment which the buyers can use with the feeling of security without impairing convenience of mail-order services, and the like, and by making the third party to issue such evidence as a paper or electronic receipt.

As discussed, a settlement system according to the present invention further has an arrangement in which the order-intake agent device inputs to the order placing device settlement completion information indicating completion of settlement of payment for the order.

With this arrangement, further, the order-intake agent device executes a settling process according to the order information obtained from the order placing device, thereafter inputting the settlement completion information generated to the order placing device which then stores the inputted information.

Consequently, the evidence of electronic settlement for mail-order services, and the like is issued by the order-intake agent who is the third party with respect to the buyer, and the evidence is stored in the order placing device whereby the order was placed. Therefore, troubles associated with trade between the buyer and the seller can be prevented, thereby removing feelings of anxiety which the buyers have with respect to trade.

As discussed, an information providing device according to the present invention is such that, in a settlement system in which an order-intake agent receives an order for merchandise placed by a buyer and settlement of payment on behalf of a seller, the information providing device offers such merchandise information as to specify the merchandise that the buyer orders to a communications network.

With this arrangement, the buyer can obtain, and store, the merchandise information offered from the information providing device to the communications network, such as the Internet, by the order placing device which is a mobile information terminal used in the settlement system. Alternatively, the merchandise information may be obtained by a personal computer, such as a desktop computer, and stored in the order placing device via infrared communications and a recording medium, such as a memory card or the like.

Therefore, the buyer can place an order for merchandise and settle payment therefor in the foregoing settlement system by storing merchandise information offered from the information providing device to the communications network and allowing the order-intake agent to obtain the merchandise information by the order intake-agent device.

Consequently, the seller of the merchandise can easily offer merchandise information from the information providing device (an e-mall on the Internet, for example) via the communications network. Further, the buyer of the merchandise can obtain merchandise information of the merchandise that the buyer desires to purchase via the communications network. Therefore, input to the order placing device is made more accurately and easily than in the case where merchandise information is obtained from a television, radio, newspaper, magazine, book, or the like.

As discussed, further, an information providing device according to the present invention provides a barcode image generated in accordance with display section specs of the order placing device based on the merchandise information with respect to the order placing device.

With this arrangement, further, the order placing device obtains from the information providing device the barcode image generated in accordance with the display section specs of the order placing device.

Therefore, even when display section specs vary depending on each order placing device, and with respect to scanning by the order-intake agent device, an optimum display layout including the display position and line width of a barcode varies, it is possible to generate, and transmit, the barcode image with the optimum display layout for each order placing device.

Consequently, the order placing device which obtained a barcode image from the information providing device can display the barcode image without troubles, such as illegible lines and deviation off the correct display position, the order-intake agent device can accurately scan and identify the barcode. Therefore, the seller can distribute merchandise information from an e-mall without limiting the display section specs of order placing devices.

As discussed, a settlement system according to the present invention, which settles payment for merchandise which a buyer orders for a seller on behalf of the seller, includes: a terminal (an order placing device) for displaying such merchandise information as to specify the merchandise that the buyer orders; and a settlement device (an order-intake agent device) for executing settlement of payment for the ordered merchandise based on the merchandise information displayed in the terminal.

It is preferable that the settlement device includes a scanner section for scanning display of the terminal, thereby properly reading the merchandise information.

Further, it is preferable that the terminal includes an input section for receiving input of a code of the merchandise information, thereby easily inputting the merchandise information and checking the already scanned merchandise information.

The merchandise information to be displayed in the terminal preferably includes a barcode image information, thereby making it possible to utilize the existing system and read the merchandise information easily and securely.

Further, the present invention can also be represented in the form of a settlement method, which settles payment for merchandise which a buyer orders for a seller on behalf of the seller, the method includes the steps of: displaying in a terminal such merchandise information as to specify merchandise which a buyer orders; and executing settlement of payment for the ordered merchandise based on the merchandise information displayed in the terminal.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A settlement system in which, when a buyer orders merchandise for a seller, an order-intake agent receives an order for the merchandise placed by the buyer and payment for the merchandise on behalf of the seller, comprising:
an order placing device for storing order information inclusive of such merchandise information as to specify the merchandise that the buyer orders; and
an order-intake agent device whereby the order-intake agent obtains the order information from the order placing device.

2. The settlement system set forth in claim 1, wherein:
the order information includes such buyer information as to specify the buyer.

3. The settlement system set forth in claim 1, wherein:
the order placing device displays the order information in the form of a barcode, and
the order-intake agent device obtains the order information by scanning the barcode displayed in the order placing device.

4. The settlement system set forth in claim 1, wherein:
the order-intake agent device inputs settlement completion information indicative of completion of settlement of payment for the order to the order placing device.

5. A settlement method in which, when a buyer orders merchandise for a seller, an order-intake agent receives an order for the merchandise placed by the buyer and payment for the merchandise on behalf of the seller, wherein:
the buyer uses an order placing device to store order information inclusive of such merchandise information as to specify the merchandise that the buyer orders, and
the seller uses an order-intake agent device so that the order-intake agent obtains the order information from the order placing device.

6. The order placing device set forth in claim 1, further comprising a barcode display section for displaying the order information in the form of a barcode.

7. An information providing device used in a settlement system in which, when a buyer orders merchandise for a seller, an order-intake agent receives an order for the merchandise placed by the buyer and payment for the merchandise on behalf of the seller, the device whereby the buyer offers to a communications network such merchandise information as to specify the merchandise that the buyer orders.

8. The information providing device set forth in claim 7, which provides the order placing device with a barcode image generated in accordance with display section specs of the order placing device based on the merchandise information.

9. A settlement system which settles payment for merchandise which a buyer orders for a seller on behalf of the seller, comprising:
a terminal for displaying such merchandise information as to specify the merchandise that the buyer orders; and
a settlement device for executing settlement of payment for the ordered merchandise based on the merchandise information displayed in the terminal.

10. The settlement system set forth in claim 9, wherein:
the settlement device includes a scanner section for scanning display of the terminal.

11. The Settlement system set forth in claim 9, wherein:
the terminal includes an input section for receiving input of a code of the merchandise information.

12. The settlement system set forth in claim 9, wherein:
the merchandise information displayed in the terminal includes barcode image information.

13. The settlement system set forth in claim 9, wherein:
the settlement device transmits to the terminal settlement completion information indicating completion of settlement of the payment.

14. A settlement program which causes a computer to function as the settlement system of claim 9.

15. A settlement method which settles payment for merchandise which a buyer orders for a seller on behalf of the seller, comprising the steps of:
displaying in a terminal such merchandise information as to specify merchandise which a buyer orders; and
executing settlement of payment for the ordered merchandise based on the merchandise information displayed in the terminal.

16. A settlement program which causes a computer to execute the settlement method of claim 15.

17. An information providing device which provides a barcode image generated in accordance with display section specs of a terminal as such merchandise information as to specify merchandise which a buyer orders, to the terminal via a communications network.
